(19) United States
(12) Patent Application Publication
(10) Pub. No.: US 2025/0164934 A1
(43) Pub. Date: May 22, 2025

(54) EXTRA-FLAT TIMEPIECE

(71) Applicant: BULGARI HORLOGERIE SA, Neuchâtel (CH)

(72) Inventors: François Perez, Founex (CH); Alfredo De Biase, Le Sentier (CH)

(73) Assignee: BULGARI HORLOGERIE SA, Neuchâtel (CH)

(21) Appl. No.: 18/842,345

(22) PCT Filed: Mar. 8, 2023
(86) PCT No.: PCT/EP2023/055859

§ 371 Date: Aug. 28, 2024

(30) Foreign Application Priority Data
Mar. 8, 2022 (CH) CH000240/2022

(51) Int. Cl. G04B 37/00; G04B 13/00

(52) U.S. Cl. CPC G04B 37/0008; G04B 13/00

(57) ABSTRACT

The timepiece (1) has a horizontal surface which is cut into four horizontal circular sectors of substantially the same size. An hour dial (6) and/or an hour wheel (18) substantially occupy a first sector, a minute dial (7) and/or a timer wheel (17) substantially occupy a second sector, a barrel (10) substantially occupies a third sector, and a balance (20) substantially occupies a fourth sector.

The present invention relates to an extra-flat timepiece. It also relates to a method for assembling or manufacturing a timepiece.

In order to create an extra-flat mechanical timepiece, one technical problem that arises is that of how best to arrange the various components of the timepiece movement within a minimal amount of space.

A general objective of the present invention is to propose an arrangement of the various components of a timepiece, particularly of the movement, in order to minimize the volume occupied by these components so as to be able to manufacture a timepiece that is extra-flat.

To this end, the invention relies upon a timepiece comprising a case, wherein a horizontal surface of the timepiece is divided into four horizontal sectors of substantially the same size and wherein said timepiece comprises an hours dial and/or an hour wheel occupying a first sector, a minutes dial and/or a minute wheel occupying a second sector neighboring the first, a barrel occupying a third sector, and a balance occupying a fourth sector.

What is meant by occupying a sector is that the surface area of the sector is occupied. The component concerned extends substantially entirely from a first limit to a second limit of the sector. In other words, it occupies a significant extent of the total surface of the sector, notably at least one third of this surface or even at least half of this surface.

The timepiece may comprise at least two independent functional modules. The independent functional modules may comprise components mounted between an upper bridge and a lower bridge.

Thus, the timepiece may comprise a balance module and a going-train module.

The balance module may further comprise an escapement and the going-train module may comprise at least three or even at least four wheels.

The timepiece may comprise a winding crown arranged near the barrel, connected to the barrel by a winding train and/or a setting crown arranged between the hours dial and/or the hour wheel and the minutes dial and/or the minute wheel, connected by a connecting device to an hour wheel and/or to a minute wheel.

The winding crown and/or the setting crown may be arranged beneath the lower surface of the timepiece.

The timepiece may comprise a minute wheel positioned beneath a minutes dial and an hour wheel positioned beneath an hours dial.

The timepiece may comprise a going train arranged between the barrel, the balance and the hour wheel and/or the minute wheel.

The timepiece may have a total thickness less than or equal to 2 mm, or even less than or equal to 1.9 mm, or even less than or equal to 1.85 mm, and/or may have a diameter greater than or equal to 30 mm, or even greater than or equal to 30 mm, and/or a diameter less than or equal to 45 mm, or even less than or equal to 40 mm.

The invention also relates to a method for assembling a timepiece as described hereinabove, wherein said method involves mounting, in four horizontal sectors of substantially the same size, an hours dial and/or an hour wheel occupying a first sector, a minutes dial and/or a minute wheel occupying a second sector neighboring the first sector, a barrel occupying a third sector, and a balance occupying a fourth sector.

The method for assembling a timepiece may involve a step that consists in mounting at least two independent functional modules on the timepiece.

Further advantages and features will become more clearly apparent from the following description of one particular embodiment of the invention, given by way of nonlimiting example depicted in the attached drawings, in which:

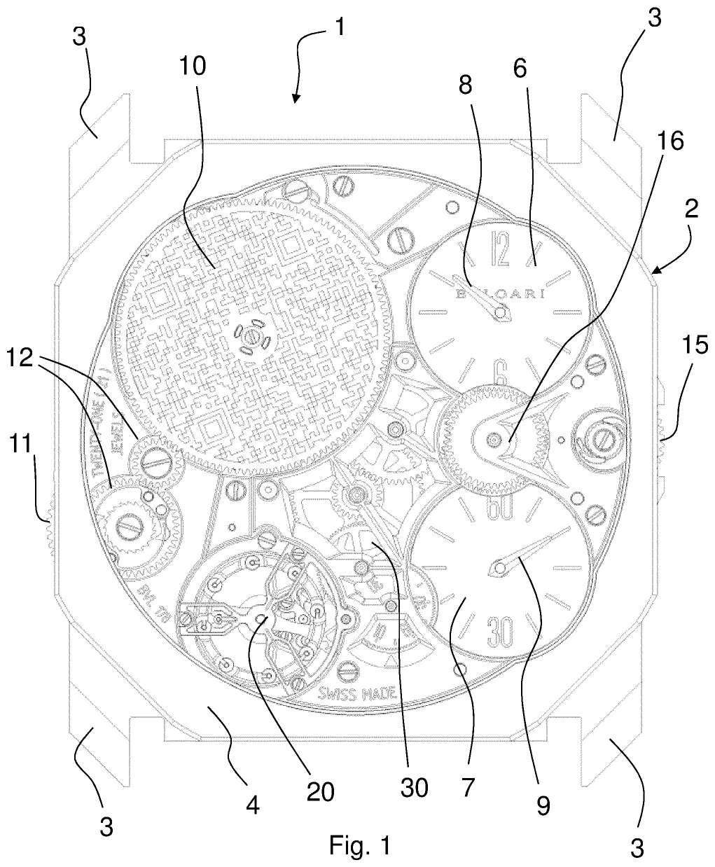

FIG. 1 depicts a view, from above, of a timepiece according to one embodiment of the invention.

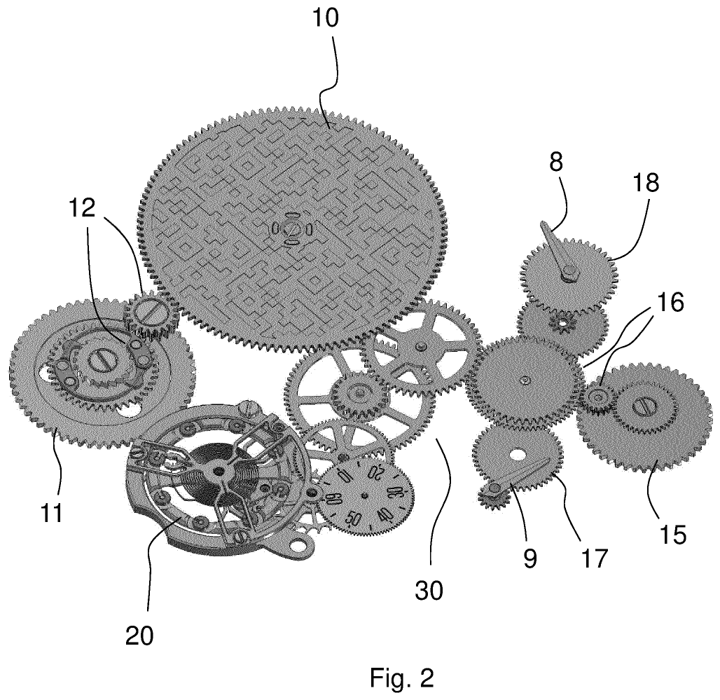

FIG. 2 depicts an exploded perspective view of part of the movement of the timepiece according to the embodiment of the invention.

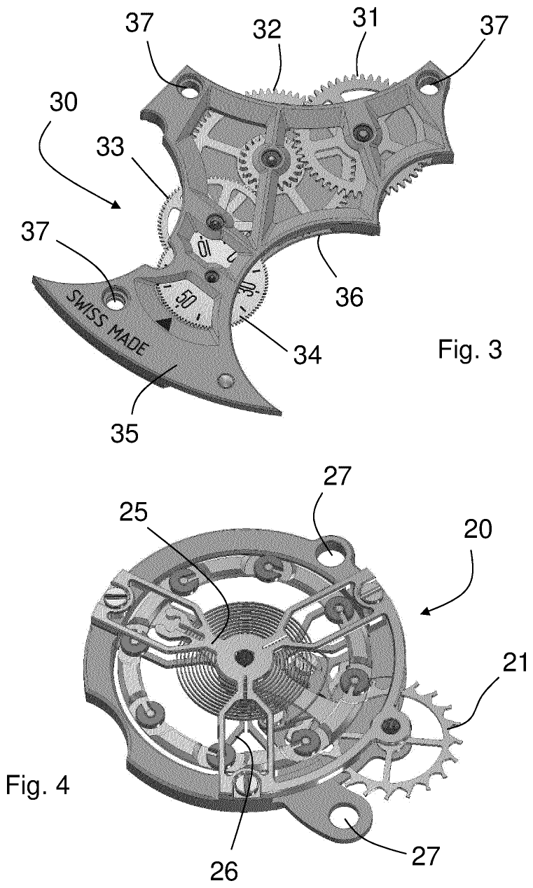

FIG. 3 depicts a perspective view of a going-train module of the timepiece according to the embodiment of the invention.

FIG. 4 depicts a perspective view of a balance and escapement module of the timepiece according to the embodiment of the invention.

In order to simplify the description, the expression “horizontal direction” will be used, by convention, to denote any direction parallel to the crystal and/or a bridge and/or a plate and/or a dial of the timepiece. The expression “vertical direction” will be used for any direction perpendicular to the crystal of the timepiece. The adjectives “upper” and “lower” will be used to denote elements or surfaces with reference to the perpendicular direction, these being positioned respectively on the side of the timepiece that faces the user and on the opposite side, for example on the side facing the wrist of a wearer in the case of a wristwatch.

According to the invention, the bulkiness of the components of a mechanical timepiece is minimized using the following two complementing and combined approaches:
The various mechanical functions are organized in the form of a plurality of independent modules, assembled outside of the timepiece, in a compact form, making them easier to mount as modules in a timepiece that has little space in which to accommodate them; and/or
The various components are positioned in an optimized manner relative to one another in the space, so as to minimize their bulk, and reduce empty space.

FIG. 1 depicts a view, from above, of a timepiece 1 according to one embodiment of the invention, comprising a case 2 which has horns 3 intended for attaching lengths of strap, which have not been depicted. According to this embodiment, the timepiece is a wristwatch. The case 2 comprises a back or plate and a case middle, and a bezel 4 arranged on the case middle around the periphery of the case 2. As an alternative, any other architecture of the case 2 is conceivable. A crystal, not depicted, is intended to be mounted on the upper surface of the timepiece.

The case 2 delimits a volume in which all the components of the mechanical timepiece 1, which is to say mainly the movement and the dials, need to be housed. According to this embodiment, the timepiece 1 is an extra-flat wristwatch of very small thickness. There is therefore little space in such a timepiece 1 in which to distribute components in the vertical direction, and their distribution in the horizontal plane, which is visible in FIG. 1, is therefore very important to succeeding in minimizing the overall volume of the timepiece 1 and therefore offering the flattest possible timepiece 1. Thus, this optimal horizontal distribution offers a first way of addressing the issue of minimizing the overall bulk of the timepiece 1.

According to this embodiment, the overall thickness of the timepiece 1 is less than or equal to 2 mm or even less than or equal to 1.9 mm, or even less than or equal to 1.85 mm. This thickness may be greater than or equal to 1.7 mm.

First of all, in FIG. 1, it is possible to discern between four principal subassemblies, referred to as “principal” by reference to their significant surface area, when considering the horizontal plane of the timepiece. Note that as the solution is suited to an extra-flat watch, it seeks to limit any 15 superposition of functions or of components in the vertical direction. Using a simplified approach, the watch movement may thus be analyzed by considering a two-dimensional horizontal plane in which the maximum of components and functions are arranged, thereby making it possible to minimize the height of the movement in the vertical direction. In other words, in this embodiment, the four subassemblies occupy, which is to say fill or exhibit, the four greatest surface areas within the case 2, and therefore represent the greatest constraints in terms of bulk on positioning them in said horizontal plane of the timepiece. According to this embodiment, each subassembly is substantially in the form of a disk (at least in horizontal section). As a variant, other shapes might be conceivable. The four disks of the four principal subassemblies respectively are distributed about the periphery of the timepiece. Specifically, each of these four principal subassemblies comprises an end that is positioned at the boundary of the horizontal plane of the timepiece, which is to say at the margins of the bezel 30 4 and/or of the case middle of the case 2 of the timepiece 1.

A first subassembly is an hours dial 6 on which an hours hand 8 indicates the hour. A neighboring second subassembly is a minutes dial 7 on which a minutes hand 9 indicates the minutes. What is therefore meant by the adjective “neighboring” is that these subassemblies are positioned in neighboring sectors according to the division into sectors as explained earlier. Note that it is advantageous to separate these two indications into two separate dials, in order to minimize the overall height, by comparison with a traditional embodiment in which one single dial might combine the indication of the hours and of the minutes using two separate hands superposed in the vertical direction.

In addition, a third subassembly is formed by a barrel 10, the diameter of which is dependent on the desired power reserve. Lastly, a fourth subassembly is formed by a balance 20.

Finally, these four subassemblies are distributed each in substantially a different quarter of the overall horizontal surface of the timepiece 1. Through this construction, these four subassemblies are not superposed in the vertical direction, thereby making it possible to minimize the overall height of the movement and the thickness of the timepiece. In other words, this surface can be divided into four sectors of substantially the same size, forming the above-mentioned four quarters. According to the embodiment depicted, the barrel 10 occupies a surface that extends slightly beyond one of the sectors of this surface, whereas the other three subassemblies 6, 7, 20 occupy a surface that is slightly smaller than one of the four sectors of this surface. Naturally, the relative surfaces of these four subassemblies are liable to vary. In addition, their relative positionings may be modified, the two dials 6, 7 nevertheless advantageously continuing to be neighboring. Note that the dials 6, 7 could be omitted, for example in a skeleton type variant of the timepiece. In that case, an hour wheel and a minute wheel would occupy the first and second sectors, respectively.

Advantageously, the first two sectors are distributed on a left-hand or right-hand side of the watch, to collaborate with a first crown that will be described later, and the other two sectors are distributed on the other side.

The above arrangement frees up enough space for distributing the following complementary functions of the timepiece 1:
A winding crown 11, arranged in such a way as to protrude partially from the case 2 in order to be operated by a user. This winding crown 11 is positioned near to the barrel 10 and is connected to the barrel 10 by a winding train 12, comprising for example a ratchet wheel and a winding intermediate wheel;
A setting crown 15, arranged between the two dials 6, 7, and arranged in such a way as to protrude partially from the case 2 in order to be operated by a user. This setting crown 15 is connected to at least one of the hour and minute wheels by a connecting device 16 which is not detailed but which is arranged at least partially between the two dials 6, 7;
A going-train module 30, more particularly depicted in FIG. 3, which globally connects the barrel 10, the balance 20 and the hour and minute wheels, visible in FIG. 2. This going-train module 30 extends substantially in the central part of the timepiece 1, substantially between the above-mentioned four principal subassemblies. It may be considered to form a fifth subassembly of the movement, with a more irregular shape than the four subassemblies described above, so that it occupies the intervening space left unoccupied by these four subassemblies. As described previously, what is meant by “occupying the space” is occupying the surface area of the space and therefore occupying substantially all of the space or a significant surface area of this space.

The principal components of the movement of the timepiece 1 are more particularly visible in exploded perspective in FIG. 2. In that figure there may be seen a minute wheel 17, intended to be positioned substantially beneath the minutes dial 7, and an hour wheel 18, intended to be positioned substantially beneath the hours dial 6, wheels forming a connecting device 16, notably of differential type, between the setting crown 15 and the minute wheel 17 and hour wheel 18. It is also possible to discern the winding crown 11, substantially diametrically opposite the setting crown 15, the balance 20, the winding train 12, the barrel 10 and the going train 30.

According to the invention, several functions of the movement additionally take the form of independent modules, to make it easier to mount them in the small space available in the timepiece 1, since all the components are brought as close together as possible in order to minimize bulk. Such a module comprises several components of the movement, for example several wheels, which are mounted between two bridges, so as to form an independent assembly that can be transported, stored and assembled independently and easily.

Thus, according to the embodiment, the timepiece 1 comprises a first, going-train module 30, depicted in FIG. 3. It comprises an upper bridge 35, superposed with a lower bridge 36, not readily visible, between which bridges a plurality of wheels are rotatably mounted. According to this embodiment, the going-train module therefore more particularly comprises a barrel intermediate wheel 31, intended to collaborate both with the barrel 10 and with the connecting device 16, which meshes with a center wheel 32, which meshes with a third wheel 33 which meshes with a fourth or seconds wheel 34 intended to collaborate with the balance module 20 that will be described below. The bridges 35, 36 are provided with through-openings 37 for attaching them, preferably removably, in the timepiece 1.

As a variant, the going-train module 30 could have a different architecture, for example comprising three wheels, four wheels or five wheels (or more generally other elementary single-piece components).

The timepiece additionally comprises a balance module 20, depicted in FIG. 4. It comprises an upper bridge 25 and a lower bridge 26 between which the balance staff is fixed, and the balance assembly 20, notably a balance spring and a balance wheel felloe, and between which an escape wheel 21 is fixed.

As a variant, the above modules could have some architecture other than that described, for example including other components. As a further variant, functional modules other than those described above could take modular form and be used in addition to, or as a replacement for, the modules described above. Thus, the timepiece comprises at least two functional modules, and may comprise three, four, five or more thereof.

A functional module may be fixed to the timepiece by screw-fastening or even using any other fixing means.

Note that the above description demonstrates that the components of the timepiece 1, notably of the movement, are distributed over few overlapping planes, so as to minimize thickness. In order to reduce the overall thickness still further, it is advantageous according to the embodiment of the invention to position at least one of the two crowns that are the winding crown 11 and the setting crown 15 at the lower surface of the timepiece, which is to say under the back of the timepiece 1. For that purpose, it is connected to the movement by a stem or shaft that is substantially vertical and that passes through an opening in the back of the timepiece 1. The back may have a shape comprising a non-planar setback in the region of this crown, so that the crown lies substantially continuous with the underside surface of the timepiece.

In this way, the invention is able to achieve the surprising result of forming an extra-flat mechanical timepiece, in wristwatch format, comprising all the mechanical functions that are essential to high-performance indication of time. The timepiece 1 thus for example has a diameter greater than or equal to 30 mm, or even greater than or equal to 35 mm. In addition, it has a diameter less than or equal to 45 mm, or even less than or equal to 40 mm. Its outline may be circular. As a variant, it may have any other shape, square, rectangular, ellipsoidal, etc. In all instances, its surface area may remain within the same values as those resulting from the aforementioned range of diameters.

The invention relates to a timepiece per se, which may be extra-flat, as described hereinabove. Naturally, the invention remains implementable in respect of any other timepiece, not necessarily flat.

The invention also relates to a method for assembling a timepiece, wherein said method involves mounting, in four horizontal sectors of the same size, an hours dial 6 occupying a first sector, a minutes dial 7 occupying a second sector neighboring the first sector, a barrel 10 occupying a third sector, and a balance 20 occupying a fourth sector.

The method may involve a step that consists in mounting at least two independent functional modules on the timepiece.

Advantageously, the method comprises a step of regulating the modules of the movement after assembling them into the timepiece. As a variant, these modules may be temporarily removed so that they can be regulated outside of the timepiece if necessary, before being refitted. The removal/refitting operation can be performed several times if necessary.

1. A timepiece comprising a case,
wherein a horizontal surface of the timepiece is divided into four horizontal sectors of substantially the same size, and
wherein the timepiece comprises;
an hours dial and/or an hour wheel occupying a surface of a first sector,
a minutes dial and/or a minute wheel occupying a surface of a second sector neighboring the first sector,
a barrel occupying a surface of a third sector, and
a balance occupying a surface of a fourth sector, the hours dial and/or the hour wheel,
the minutes dial and/or the minute wheel, the barrel and the balance each being distributed in a different quarter of the overall horizontal surface of the timepiece.

2. The timepiece as claimed in claim 1, wherein the timepiece comprises at least two independent functional modules.

3. The timepiece as claimed in claim 2, wherein the at least two independent functional modules comprise components mounted between an upper bridge and a lower bridge.

4. The timepiece as claimed in claim 2, wherein the timepiece comprises a balance module and a going-train module.

5. The timepiece as claimed in claim 4, wherein the balance module further comprises an escapement and the going-train module comprises at least three wheels.

6. The timepiece as claimed in claim 1, wherein the timepiece comprises a winding crown arranged near the barrel, connected to the barrel by a winding train and/or a setting crown arranged between the hours dial and/or the hour wheel and the minutes dial and/or the minute wheel, connected by a connecting device to an hour wheel and/or to a minute wheel.

7. The timepiece as claimed in claim 6, wherein the winding crown and/or the setting crown is arranged beneath the lower surface of the timepiece.

8. The timepiece as claimed in claim 6, wherein the timepiece comprises a minute wheel positioned beneath a minutes dial and an hour wheel positioned beneath an hours dial.

9. The timepiece as claimed in claim 1, wherein the timepiece comprises a going train arranged between the barrel, the balance and the hour wheel and/or the minute wheel.

10. The timepiece as claimed in claim 1, wherein the hours dial and/or the hour wheel, the minutes dial and/or the minute wheel, the barrel and the balance are not superposed with one another, so as to limit a thickness of the timepiece.

11. The timepiece as claimed in claim 1, wherein each of the hours dial and/or the hour wheel, the minutes dial and/or the minute wheel, the barrel and the balance has one end that is positioned at a boundary of a horizontal plane of the timepiece, and at margins of a bezel and/or of a case middle of the case of the timepiece.

12. The timepiece as claimed in claim 1, wherein the hours dial and/or the hour wheel, the minutes dial (and/or the minute wheel, the barrel and the balance have the four greatest surface areas within the case.

13. The timepiece as claimed in claim 1, wherein the timepiece has a total thickness less than or equal to 2 mm, and/or wherein the timepiece has a diameter greater than or equal to 30 mm.

14. A method for assembling a timepiece, wherein the method comprises:
mounting, in four horizontal sectors having substantially a same size:
an hours dial and/or an hour wheel occupying a first sector,
a minutes dial and/or a minute wheel occupying a second sector neighboring the first sector,
a barrel occupying a third sector, and
a balance occupying a fourth sector,
so as to obtain the timepiece as claimed in claim 1.

15. The method for as claimed in claim 14, wherein the method comprises mounting at least two independent functional modules on the timepiece.

16. The timepiece as claimed in claim 5, wherein the balance module further comprises an escapement and the going-train module comprises at least four wheels.

17. The timepiece as claimed in claim 3, wherein the timepiece comprises a balance module and a going-train module.

18. The timepiece as claimed in claim 17, wherein the balance module further comprises an escapement and the going-train module comprises at least three wheels.

19. The timepiece as claimed in claim 18, wherein the balance module further comprises an escapement and the going-train module comprises at least four wheels.

20. The timepiece as claimed in claim 13, wherein the timepiece has a total thickness less than or equal to 1.85 mm, and/or wherein the timepiece has a diameter greater in a range of from 30 mm to 45 mm.
